(19) United States
(12) Patent Application Publication
(10) Pub. No.: US 2026/0149823 A1
(43) Pub. Date: May 28, 2026

(54) QUANTIZATION PARAMETER (QP) CODING FOR VIDEO COMPRESSION

(71) Applicant: Telefonaktiebolaget LM Ericsson (publ), Stockholm (SE)

(72) Inventors: Rickard SJÖBERG, Stockholm (SE); Martin PETTERSSON, Vallentuna (SE); Jacob STRÖM, Stockholm (SE)

(73) Assignee: Telefonaktiebolaget LM Ericsson (publ), Stockholm (SE)

(21) Appl. No.: 19/119,891

(22) PCT Filed: Oct. 10, 2023
(86) PCT No.: PCT/SE2023/051013

§ 371 Date: Apr. 10, 2025

Related U.S. Application Data
(60) Provisional application No. 63/415,810, filed on Oct. 13, 2022.

(51) Int. Cl. H04N 19/44; H04N 19/105; H04N 19/172; H04N 19/70

(52) U.S. Cl. CPC H04N 19/44; H04N 19/105; H04N 19/172; H04N 19/70

(57) ABSTRACT

There is provided a method (600) for decoding a current coded picture from a video bitstream. The method comprises deriving a list of delta quantization parameter, QP, values from parameter set syntax elements in the video bitstream. The method comprises deriving an index value, IV, from a slice header, a segment header or a picture header, associated with the current coded picture. The method comprises deriving a delta QP value for the current coded picture using the derived list of delta QP values and the IV. The method comprises using the derived delta QP value to derive an initial QP value, QPi, for the current coded picture. The method comprises using the initial QP value in a decoding process to decode the current coded picture or segment thereof.

### TECHNICAL FIELD

Disclosed are embodiments related to video compression.

### BACKGROUND

### 1. Versatile Video Coding (VVC) and High Efficiency Video Coding (HEVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original sample data and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### 2. Components

A video sequence consists of a series of pictures where each picture consists of one or more components. A picture in a video sequence is sometimes denoted ‘image’ or ‘frame’. Each component in a picture can be described as a two-dimensional rectangular array of picture sample values (or “sample values” or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### 3. Coding Units and Coding Blocks

In many video coding standards, such as HEVC and VVC, each component of a picture is split into blocks and the coded video bitstream consists of a series of coded blocks. A block is a two-dimensional array of samples. It is common in video coding that the picture is split into units that cover a specific area of the picture.

Each unit consists of all blocks from all components that make up that specific area and each block belongs fully to one unit. The macroblock in H.264 and the Coding Unit (CU) in HEVC and VVC are examples of units. In VVC the CUs may be split recursively to smaller CUs. The CU at the top level is referred to as the coding tree unit (CTU). A CU usually contains three coding blocks, i.e. one coding block for luma and two coding blocks for chroma. A block to which a transform used in coding is applied is referred to as a “transform block.” And a block to which a prediction mode is applied is referred to as a “prediction blocks.”

### 4. Network Abstraction Layer (NAL)

HEVC and VVC define a Network Abstraction Layer (NAL). A NAL unit is a data structure that contains data. A so-called Video Coding Layer (VCL) NAL unit contains data that represents picture sample values. A non-VCL NAL unit contains additional associated data such as parameter sets and supplemental enhancement information (SEI) messages. The NAL unit in HEVC begins with a 2-byte header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The bytes after the 2-byte NAL unit header is payload of the type indicated by the NAL unit type. A bitstream consists of a series of concatenated NAL units.

### 5. Slices and Tiles

The concept of slices in HEVC divides the picture into independently coded slices, where decoding of one slice in a picture is independent of other slices of the same picture. Different coding types could be used for slices of the same picture, i.e., a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### 6. Decoding Order, Output Order and Temporal Sublayers

Two important concepts in video coding are the concepts of decoding order and output order. Decoding order is the order in which the pictures are decoded. This is typically the same order as the pictures are encoded as well as the order in which the coded pictures are transmitted. Output order is the order in which pictures are output from the decoder.

In HEVC and VVC, the NAL unit has a nuh_temporal_id_plus1 syntax element and the Temporal ID of the NAL unit is set to the value of nuh_temporal_id_plus1 minus 1. All VCL NAL units for one picture must have the same Temporal ID value which then specifies what temporal sublayer the picture belongs to. A sublayer with Temporal ID equal to x is said to be the x-th sublayer or sublayer x. The encoder is required to set Temporal ID values such that pictures belonging to a lower temporal sublayer is perfectly decodable if higher temporal sublayers are discarded. This is ensured by restrictions in the HEVC and VVC specifications that the encoder must comply with. For instance, it is not allowed for a picture of a temporal sublayer to reference a picture of a higher temporal sublayer. Assume for instance that an encoder has output a bitstream using temporal sublayers 0, 1 and 2. Then removing all temporal sublayer 2 NAL units or removing all temporal sublayer 1 and 2 NAL units will result in bitstreams that can be decoded without problems. An example of temporal sublayers is illustrated in Table 1

TABLE 1
Temporal sublayer example (sub-GOP size = 4)

| | | | | | | | | |
|---|---|---|---|---|---|---|---|---|
| 2 | X | | X | | X | | X | |
| 1 | | X | | | | X | | |
| 0 | | | | X | | | | X |
| Output order | 0 | 1 | 2 | 3 | 4 | 5 | 6 | 7 |
| Decoding order | 2 | 1 | 3 | 0 | 6 | 5 | 7 | 4 |
| Temporal ID | 2 | 1 | 2 | 0 | 2 | 1 | 2 | 0 |

Table 1 contains 8 pictures, each indicated by an X, and where each picture is associated with an output order value, a decoding order value and a Temporal ID value. The 8 pictures are output or displayed in the order from left to right, in increasing value of output order that is. The decoding order values shows the order in which the pictures are decoded. This is also the order of the coded pictures in the bitstream. As an example, the entry ‘2’ in the first column of the ‘Decoding order’ row signifies that there are two pictures in front of this picture in decoding order in the sub-GOP, namely the pictures in the second and fourth column. The entry ‘0’ in the fourth column indicates that this is the first picture in decoding order in the sub-GOP. There are three temporal sublayers in the example, sublayer 0, 1 and 2. The sublayers are shown by the Temporal ID values and are illustrated by the vertical position of each picture in the figure. In HEVC and VVC, there is a rule that no picture of a lower Temporal ID may use any picture of a higher Temporal ID for prediction. That is an important rule since it enables removal of higher temporal sublayers without affecting the decodability of the remaining lower temporal sublayers. For instance, if temporal sublayer 2 were to be removed in the example above, temporal sublayers 0 and 1 would be decodable since no sublayer 2 picture was allowed to be referenced by any sublayer 0 or 1 picture. Note that an HEVC or VVC encoder may assign all picture to sublayer 0, then the rule cannot be violated.

In this disclosure we use the term “temporal sublayer” or “sublayer” when we refer to temporal sublayers.

### 7. Hierarchical Structure of Pictures

Table 1 is an example of a so-called hierarchical structure of pictures. The sub-GOP size in this example is 4 since the distance in terms of pictures between the pictures in the lowest sub-layer is equal to 4. It is common in video coding to use hierarchical structures of pictures since they have been proven to provide good compression efficiency. Commonly a sub-GOP size is a power of two, such that the sub-GOP size is equal to one of 2, 4, 8, 16, 32, etc. Each such structure of pictures of size N can be constructed from the structure of size N/2 by adding a new highest sublayer where new pictures are added in-between the pictures of the size N/2 structure. Table 2 and Table 3 show sub-GOP sizes 8 and 16, respectively.

TABLE 2
Temporal sublayer example (sub-GOP size = 8)

| | | | | | | | | |
|---|---|---|---|---|---|---|---|---|
| 3 | X | | X | | X | | X | |
| 2 | | X | | | | X | | |
| 1 | | | | X | | | | |
| 0 | | | | | | | | X |
| Output order | 0 | 1 | 2 | 3 | 4 | 5 | 6 | 7 |
| Decoding order | 3 | 2 | 4 | 1 | 6 | 5 | 7 | 0 |
| Temporal ID | 3 | 2 | 3 | 1 | 3 | 2 | 3 | 0 |

TABLE 3
Temporal sublayer example (sub-GOP size = 16)

| | | | | | | | | | | | | | | | | |
|---|---|---|---|---|---|---|---|---|---|---|---|---|---|---|---|---|
| 4 | X | | X | | X | | X | | X | | X | | X | | X | |
| 3 | | X | | | | X | | | | X | | | | X | | |
| 2 | | | | X | | | | | | | | X | | | | |
| 1 | | | | | | | | X | | | | | | | | |
| 0 | | | | | | | | | | | | | | | | X |
| Output order | 0 | 1 | 2 | 3 | 4 | 5 | 6 | 7 | 8 | 9 | 10 | 11 | 12 | 13 | 14 | 15 |
| Decoding order | 4 | 3 | 5 | 2 | 7 | 6 | 8 | 1 | 11 | 10 | 12 | 9 | 14 | 13 | 15 | 0 |
| Temporal ID | 4 | 3 | 4 | 2 | 4 | 3 | 4 | 1 | 4 | 3 | 4 | 2 | 4 | 3 | 4 | 0 |

### 8. Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g., parameter sets) to be provided by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

### 9. Picture Header

VVC includes a picture header syntax structure that contains syntax elements that are common for all slices of the associated picture. This syntax structure can either be conveyed in its own NAL unit or be included in a slice header when there is only one slice in the picture. When conveyed in a NAL unit, the NAL unit type is equal to a value that indicates that the NAL unit contains a picture header. The values of the syntax elements in the picture header are used to decode all slices of one picture.

### 10. Decoding Capability Information (DCI)

In VVC there is a DCI NAL unit. The DCI specifies information that doesn't change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC version 1, the general constraint information can be signaled in the DCI, VPS or SPS.

### 11. Decoded Picture Buffer (DPB)

Decoded pictures are stored by the decoder so that they can be used for temporal prediction when decoding future pictures. Those pictures are commonly stored in a decoded picture buffer (DPB). The DPB conceptually consists of a limited number of picture buffers where each picture buffer holds all sample data and motion vector data that may be needed for decoding of future pictures. In HEVC, sample data is needed for motion compensation and motion vector data is needed for temporal motion vector prediction (TMVP). Each picture in the DPB is marked as either “used for short-term reference”, “used for long-term reference”, or “unused for reference”. A picture is stored in the DPB either because it may be used for prediction during decoding or because it is waiting for output. The DPB has a limited size that limits the amount of memory the decoder needs to allocate as well as the number of reference pictures an encoder may use. The memory size is specified by a bitstream level that can be indicated in the bitstream or signaled by the system. A decoder is typically claiming conformance to a specific level which means that it is capable of decoding all bitstreams conforming to that level and lower levels. The decoder may allocate the maximum number of bytes specified by the level and be certain that all bitstreams of that level and lower are decodable.

### 12. Picture Order Count (POC)

Pictures in HEVC are identified by their picture order count (POC) values, also known as full POC values. The POC value also indicates the output order of the pictures, such as a picture with a lower POC value is output before a picture with a higher POC value. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC and VVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC and VVC. Usually, PicOrderCntVal for the current picture is simply called PicOrderCntVal.

### 13. Reference Picture Set

Reference Picture Sets are a concept in HEVC that defines how previously decoded pictures are managed in a decoded picture buffer (DPB) in order to be used for reference, i.e., sample data prediction and motion vector prediction. In other words, what pictures to store in memory is in HEVC signaled using RPS. An RPS is a set of indicators to previously decoded pictures and the RPS is signalled or indicated in each slice header. An RPS is signaled in each slice header in HEVC. All pictures in the DPB that are not included in the RPS are marked as “unused for reference”. Once a picture has been marked “unused for reference” it can no longer be used for prediction, and when it is no longer needed for output, it will be removed from the DPB. In HEVC, the RPS is signalled as a set of delta POC values relative to a current picture. As an example, the RPS information may contain the values −4, −6, 4.

This then means that given that the picture has a POC value equal to 100, the current picture can use the pictures having POC values equal to 96, 94 and 104 for prediction. In this example, the RPS also indicates that any picture having any other POC value will never be used for predication in the future. This is a robust way for the decoder to discard pictures.

An HEVC SPS may contain a list of RPSs, and such an RPS can be referred to by a slice header. The HEVC slice header then include a syntax element short_term_ref_pic_set_idx that specifies which entry in the SPS list of RPSs to use for the current slice.

The RPS signaling in HEVC also includes a mechanism for predicting an entry in the list of RPSs from another, previously signaled, entry. This prediction is enabled when the inter_ref_pic_set_prediction_flag in HEVC is equal to 1.

Sometimes the encoder may want the decoder to save a picture although it is not going to be used for prediction in the current frame. This is signaled by a flag for each value called used_by_curr_pic_flag. If used_by_curr_pic_flag is equal to 1, this means that the picture can indeed be used for prediction for the current frame. If it is equal to 0, this instead means that the decoder cannot predict from it, but it must keep it in the DPB since future pictures may predict from it. We may use the convention that if a reference picture is marked by a star (*), then used_by_curr_pic_flag equals 0, otherwise used_by_curr_pic_flag equals 1. Hence −4, −6*, 4 means that the decoder may predict from the POC==96 and POC==104 pictures, but not from the POC==94 picture. Still, the decoder cannot throw away the 94 pictures since it may be used for prediction by future pictures.

### 12. Reference Picture Lists

When decoding a picture, references to previous pictures are handled by reference picture lists. For each picture, HEVC uses at most two reference picture lists, an L0 reference picture list (or “L0 list” for short) and an L1 reference picture list (or “L1 list” for short), and those lists may only contain pictures in the RPS that are set to “used by cur pic.” P-pictures use L0 lists and B-pictures use L0 and L1 lists. When inter prediction is used for a block, the decoder derives a reference index value for L0, and possibly L1, and uses those reference index values as indices in the L0 and L1 lists to determine which reference picture(s) to use for the block.

### 13. Reference Picture List in VVC

VVC uses parts of the reference picture set idea, but instead of signaling the RPS as in HEVC, the VVC specification allows signaling of the L0 and L1 lists in the SPS. For each of the L0 and L1 lists, the number of “active” pictures is signalled in the PPS with an option to override this number in the slice header. Active pictures are reference pictures that are kept in the DPB and can be used for reference by the current picture while inactive pictures must be kept in the DPB but are not used for reference by the current picture. Inactive pictures correspond to pictures with used_by_curr_pic_flag equal to 0 in HEVC.

When the L0 and L1 lists in VVC are signaled in the SPS, the decoder can be seen as constructing one list of L0 lists and one list of L1 lists. Each entry in those two lists is a reference picture list. FIG. 4 shows an example.

The SPS syntax in VVC for conveying these lists to the decoder includes an sps_num_ref_pic_lists[0] codeword that specifies the size of the list of L0 lists. For the example shown in FIG. 4, that size is equal to 3. Then, for each of the 3 entries, the codewords in the ref_pic_list_struct( ) syntax structure as specified in VVC, not shown here, follows. This syntax structure includes a codeword for the size of the L0 list followed by codewords specifying the values of the L0 list. In the FIG. 4 example, the sizes of the three L0 lists are all equal to 5. Thereafter, the sps_num_ref_pic_lists[1] codeword follows, that specifies the size of the list of L1 lists with its ref_pic_list_struct( ) syntax following. In the FIG. 4 example, the size of the list of L1 lists is equal to 2 and the sizes of the L1 lists are 2 and 1 respectively.

A VVC decoder may later, when decoding a picture header or slice header, reference L0 and L1 lists that were decoded from the SPS rather than decoding them from the picture header and slice header themselves. If a particular L0 or L1 list is used by many coded pictures that reference the same SPS, it is more bit-efficient if the lists are conveyed in the SPS. When SPS referencing is not done, the picture header or slice header contains a ref_pic_list_struct( ) syntax structure, so the syntax for the L0 and L1 lists is very similar regardless of whether it is positioned in the SPS or picture header or slice header in VVC.

Using FIG. 4 as an example, a VVC decoder may from a ref_pic_lists( ) syntax structure in a picture header or slice header decode a syntax element flag called rpl_sps_flag as equal to 1 for L0. The rpl_sps_flag indicates whether to use an RPL from the SPS or explicitly decode it from the picture header or slice header. Then the next syntax element is an index value, rpl_idx, that specifies which entry in the list of L0 lists to use. For example, if that index value is equal to 0, then the decoder will use a reference picture list L0 equal to {−32, −64, −48, −40, −36} for the picture associated with the picture header or slice header.

Thereafter, the VVC decoder may decode the flag rpl_sps_flag as equal to 1 for L1 as well, followed by deriving an index value. This index value may for example be equal to 1, which then means that the decoder will use a reference picture list L1 equal to {16}.

### 14. Residuals, Transforms, and Quantization

A residual block consists of samples that represents sample value differences between sample values of the original source blocks and the prediction blocks. The residual block is processed by the encoder using a spatial transform to produce transform coefficients (In the decoder, the inverse transform is used to produce a residual block from transform coefficients). In the encoder, the transform coefficients are quantized according to a quantization parameter (QP) value which controls the precision of the quantized coefficients. The quantized coefficients can be referred to as residual coefficients. A high QP value would result in low precision of the residual coefficients and thus low fidelity of the residual block. A decoder receives the residual coefficients, applies inverse quantization and inverse transform to derive the residual block.

In VVC, a QP value is typically assigned to each block during decoding. Each block belongs to a slice and a slice QP value is derived for each slice from parameter set and slice header syntax elements. In VVC, the derivation of the slice QP value includes decoding a delta QP value that is either decoded from the picture header syntax structure or from the slice header as follows:

$$SliceQpY = 26 + pps\_init \_qp \_minus26 + qp\_delta ,$$

where SliceQpY is the slice QP value for the slice, pps_init_qp_minus26 is a syntax element in the PPS that the slice refers to and qp_delta is a delta QP syntax element in the picture header syntax structure or slice header.

The blocks in a slice are decoded in a deterministic scan order. During decoding of a block, a QP value is maintained and used for decoding the block (this QP value is referred to as the current QP value). The current QP value for the first block in a slice is initialized to be equal to the slice QP value. Optionally, a delta QP syntax element is decoded for the block, and if so, the decoded value of the syntax element (i.e., a delta QP value) is added to the slice QP value to form the current QP value for the block. For any block that follows in scan order, the current QP value may be updated before decoding. In this manner, the VVC codec supports flexible assignment of QP values for the blocks. In this disclosure, “delta QP value” and “QP offset value” are synonymous.

### SUMMARY

Certain challenges presently exist. For instance, the derivation of the slice QP value is not as efficient as it could be.

Accordingly, in one aspect there is provided a method for decoding a current coded picture from a video bitstream. The method includes deriving a list of delta quantization parameter, QP, values from parameter set syntax elements in the video bitstream. The method also includes deriving an index value, IV, from one or more syntax elements in a slice header, a segment header or a picture header, associated with the current coded picture. The method also includes deriving a delta QP value for the current coded picture using the derived list of delta QP values and the IV. The method also includes using the derived delta QP value to derive an initial QP value, QPi, for the current coded picture. The method further includes using the initial QP value in a decoding process to decode the current coded picture or segment thereof.

In another aspect there is provided a method for deriving a virtual temporal ID value from a coded video bitstream. The method includes decoding a first value representing a decoding order value from a first syntax element in the bitstream. The method also includes decoding a second value from a second syntax element in the bitstream representing a sub-GOP size wherein the second value represents the log 2 of the sub-GOP size. The method also includes deriving a POC value from the first value, wherein the POC value is derived from the first value by an index look-up operation with the index in the look-up operation equal to the first value. The method further includes deriving a virtual temporal ID value from the POC value and the second value.

In some aspects, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they provide video compression bit-rate savings.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 illustrates an example of a list of L0 lists and a list of L1 lists.

FIG. 5 illustrates another example list of lists (LOL).

FIG. 6 is a flowchart illustrating a process according to an embodiment.

FIG. 7 is a flowchart illustrating a process according to an embodiment.

FIG. 8 is a block diagram of an encoding apparatus according to an embodiment.

### DETAILED DESCRIPTION

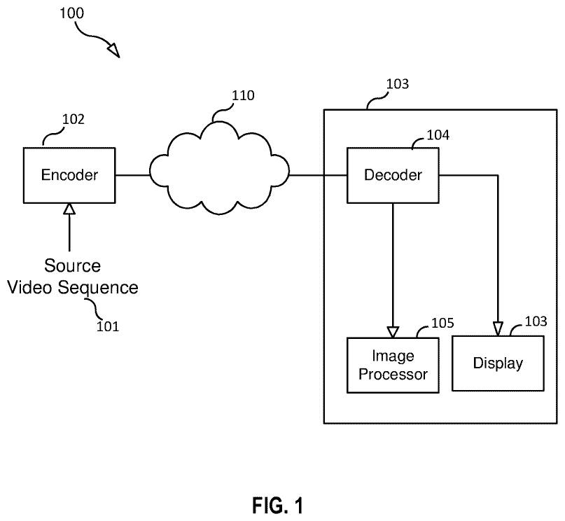

FIG. 1 illustrates a system 100 according to an embodiment. System 100 includes an encoder 102 and a decoder 104, wherein encoder 102 is in communication with decoder 104 via a network 110 (e.g., the Internet or other network). Encoder 102 encodes a source video sequence 101 into a bitstream comprising an encoded video sequence and transmits the bitstream to decoder 104 via network 110. In some embodiments, encoder 102 is not in communication with decoder 104, and, in such an embodiment, rather than transmitting bitstream to decoder 104, the bitstream is stored in a data storage unit. Decoder 104 decodes the coded pictures included in the encoded video sequence to produce video data for display and/or further image processing (e.g. a machine vision task). Accordingly, decoder 104 may be part of a device 103 having an image processor 105 and/or a display 106. The image processor 105 may perform machine vision tasks on the decoded pictures. One such machine vision task may be identifying objects in the picture. The image processor 105 may also perform image enhancements on the decoded picture. The image processor 105 may use a neural network-based algorithm for the image enhancements. The device 103 may be a mobile device, a set-top device, a head-mounted display, or any other device.

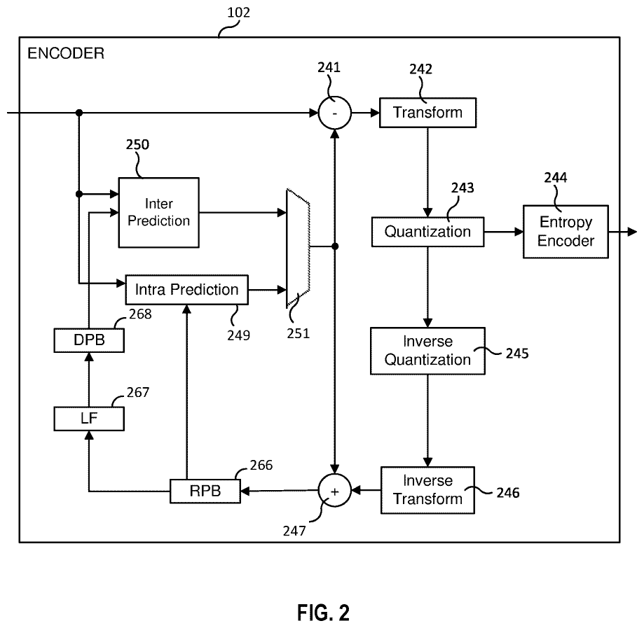

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF).

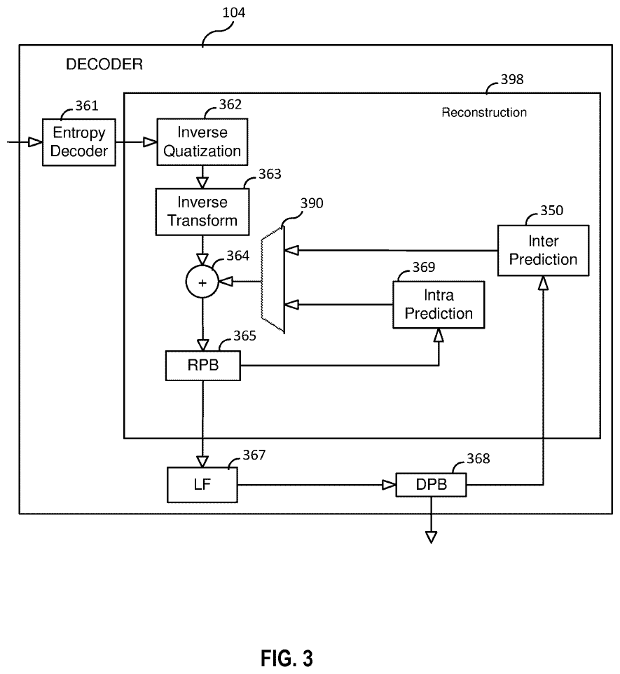

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to image processor 105. Pictures are stored in the DPB for two primary reasons: 1) to wait for picture output and 2) to be used for reference when decoding future pictures.

As described above, a challenge presently exists because the derivation of the slice QP value is not as efficient as it could be. Accordingly, this disclosure proposes a method for deriving a slice or picture QP offset value where a list of reference picture lists is decoded from a parameter set in a video bitstream. In a first embodiment, a list of QP offset values is proposed to be decoded from a parameter set, and a single index value, decoded from a slice header or a picture header of a coded picture in the video bitstream, is used to derive both the reference picture list and the QP offset value to use for the coded picture. In a second embodiment, a straightforward index look-up is done to derive the QP offset value. In a third embodiment, a virtual temporal ID value is derived from the single index value, and the QP offset value is derived with a look-up operation using the virtual temporal ID value. In a fourth embodiment, the virtual temporal ID value is derived from the single index value and a second value representing a sub-GOP size wherein the second value represents the log 2 of the sub-GOP size.

### 1. Using a Slice Header Index to Look Up Both RPL/RPS and Delta QP Value

This disclosure proposes a method for deriving a delta QP value for a coded picture when a list of reference picture lists is decoded from parameter set syntax elements of a video bitstream. Bitstream information for deriving the delta QP value is associated with a list of reference picture lists.

First, a list of delta QP values is derived from parameter set syntax element values from the video bitstream. The parameter set can be any parameter set such as DPS (a.k.a., DCI), VPS, SPS, PPS, APS, etc.

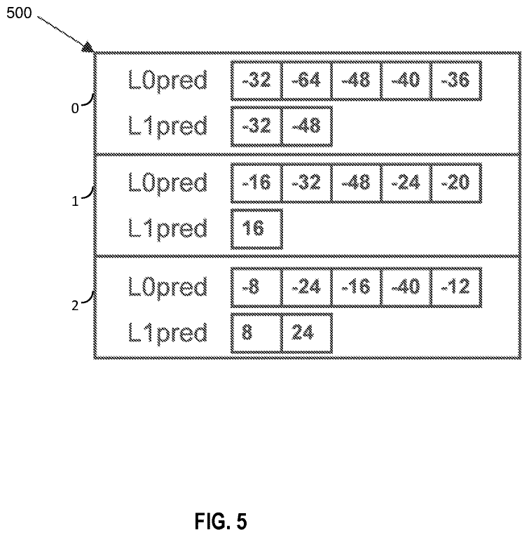

Second, a list of lists (LOL) is derived from parameter set syntax elements. The parameter set syntax elements may be derived from the same parameter set as the list of delta QP values were derived from, or from a different parameter set. The LOL comprises one or more entries, and each entry in the LOL contains at least one list of reference picture indicator values. The list of reference picture indicator values can be an “L0” list, an “L1” list, or an RPS. There are examples of such LOL in the current art, including the mechanisms for conveying RPS information in the SPS as know from HEVC and the mechanisms for conveying RPL information in VVC. The proposed method can be added on-top of HEVC or VVC, but it should be understood that the proposed method may be applied to any means of conveying an LOL of reference picture indicators. In one variant, the LOL is a list where each entry of the LOL contains or references two lists, where the first of the two lists is a list used to derive the L0 list to use for the current picture and the second of the two lists is a list used to derive the L1 list for the current picture. The L0 and L1 lists may be as described above. In some embodiments, each entry in the LOL consists of an L0 list and an L1 list. FIG. 5 illustrates an example LOL 500.

Third, an index value (IV) is decoded from the slice header or picture header syntax structure of the coded picture. The index value IV may alternatively be decoded from any header associated with one or more picture or parts of pictures. In one variant, the video coding includes partitioning a current picture into segments, and there is header information for each segment, meaning that one or more index value IV syntax elements is present for the each of the segments and can convey different values. For example, a coded picture may comprise two coded segments, segment A and segment B. The coded picture may also comprise a syntax element for each segment; let's call this syntax element element1. A decoder will in this example decode a first element1 syntax element for segment A and another second element1 syntax element for segment B, where element1 is here carrying the index value IV to use for the corresponding segment.

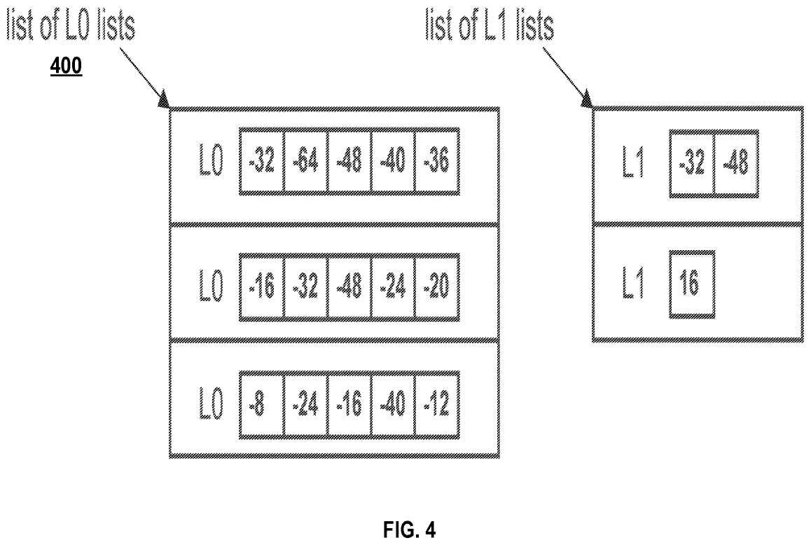

The IV is used to select an entry of the LOL, identifying one selected list of reference picture indicator values to use for the coded picture. This may be done using an index look-up operation on the LOL with the index in the index look-up operation being equal to IV. As an example using FIG. 4, the LOL is the list of L0 lists 400 which has 3 entries. These entries can be indexed as entry 0, 1, and 2. If IV is decoded to be equal to 2, the entry with index 2 is selected, which is the third entry in the list (since the indices start at 0). The selected list to use for the coded picture is then the list {−8, −24, −16, −40, −12}. In this VVC example the index value IV is the decoded value of the rpl_idx syntax element in VVC. Alternatively, the method may be implemented on top of a video codec like HEVC that uses RPSs, where the index value IV may be the decoded value of the short_term_ref_pic_set_idx syntax element in HEVC.

Note that the concept of an LOL can be realized in many ways, some of which, on the surface, do not look like a list of lists. The proposed method is intended to be used with any realization in which there exists an index value, decoded from the bitstream and associated with a one or more coded pictures or segments, that is further used to derive/select/identify a list of reference pictures to be used for the associated one or more pictures or segments. One unique feature in the proposed method is to use the index value additionally to derive a delta QP offset for the associated one or more picture or segments. The segment may be a slice.

The method also includes deriving a delta QP value for the current picture from the list of delta QP values and the IV. This means that a single IV is used both for selecting or identifying a list of reference picture indicator values as well as for deriving the delta QP value.

The derived delta QP value is then used to compute an initial QP value for the current coded picture or segment. This initial QP value may be used as the slice QP value for a slice of the current coded picture. For example, if the method is implemented on top of the VVC video coding specification, the derivation of the slice QP value may be modified as follows:

$$SliceQpY = 26 + pps\_init \_qp \_minus26 + qp\_delta + d\_delta \_QP \_value ,$$

where d_delta_QP_value is equal to the derived delta QP value.

In one version of the embodiment, an indicator value, such as a flag, is used to indicate whether to derive and add the d_delta_QP_value to the SliceQpy or not. The indicator value may be derived from a syntax element in a parameter set, e.g., the parameter set for which the list of delta QP values and/or the LOL of reference picture indicators were derived from, or it may be derived from a picture header or slice header or segment header. In one version of the embodiment d_delta_QP_value is inferred to be equal to 0, if it is determined that the novel delta QP value is not to be used, e.g., if delta QP syntax elements are not present in the parameter set syntax elements.

Additionally, both the list of reference picture indicator values and the initial QP value (SliceQpY) are used to decode the coded picture (or segment).

Accordingly, in one embodiment, a decoder may perform the following steps to decode a current coded picture (or segment) from a video bitstream:
(1) deriving a list of delta QP values (e.g. an array of delta QP values) from the parameter set syntax elements (e.g., deriving a list of entries, wherein each entry in the list comprises a delta QP value);
(2) deriving an LOL from the parameter set syntax element, wherein each entry in the LOL comprises at least one list of reference picture indicator values;
(3) deriving an index value (IV) from the slice header or segment header or picture header of the current coded picture;
(4) deriving a delta QP value for the current coded picture using the derived list of delta QP values and the IV (e.g., using the IV value to select a delta QP value from the list of delta QP values);
(5) using the derived delta QP value to derive an initial QP value (QPi) for the current coded picture (e.g., calculating QPi=X+d_delta_QP_value, where d_delta_QP_value is the derived delta QP value and X is a predicted initial QP value);
(6) using an index look-up operation on the LOL with the index equal to the IV to select from the LOL at least one list of reference picture indicator values (RPIVs); and
(7) using the initial QP value and the selected list of RPIVs in a decoding process to decode the current coded picture.

Deriving a value from one or more syntax elements in any of the above steps may comprise or consist of decoding the value from the syntax element(s) or deriving the value from a value decoded from a syntax element.

### Embodiment 2—Use of an Index

This embodiment is like embodiment 1. Here the index value is used not only to select an entry of the LOL, but also to select an entry of the list of delta QP values. This is done using an index look-up operation on the list of delta QP values with the index used in the index look-up operation being equal to the index value to derive the delta QP value. Example pseudo-code for this embodiment is shown in the table below:

TABLE 3A
int index_value = READ_SYNTAX_ELEMENT( );
List *selected_list_of_reference_picture_indicator_values =
LOL[index_value];
int delta_qp_value = LIST_of_Delta_QP_Values[index_value];
DecodeSegment(selected_list_of_reference_picture_indicator_values,
delta_qp_value);

Here, the function READ_SYNTAX_ELEMENT( ) reads a syntax element from the bitstream.

selected_list_of_reference_picture_indicator_values points to the selected at least one selected list of reference picture indicator values and it is set equal to LOL [index_value], which is the index look-up operation on the LOL with the index in the look-up operation equal to the index value to select the at least one selected list of reference picture indicator values.

delta_qp_value is the delta QP value for the current coded picture and it is set equal to LIST_of_Delta_QP_Values [index_value], which is the index look-up operation on the list of delta QP values with the index in the index look-up operation being equal to the index value.

The DecodeSegment( ) function decodes the current coded picture or the current coded segment, where a segment may be a slice. The values of selected_list_of_reference_picture_indicator_values and delta_qp_value is used during the decoding of the current coded picture or segment.

### Embodiment 3—Use of a Virtual Temporal ID Value

This embodiment is also like embodiment 1. Here, deriving the delta QP value for the current coded picture from the list of delta QP values and the index value comprises deriving a virtual temporal ID value from the index value and then deriving the delta QP value from the virtual temporal ID value. In this embodiment, a hierarchical structure of pictures can be assumed, and the index value is tightly coupled with the decoding order of pictures in the bitstream.

A virtual temporal ID value can be seen as equal to the Temporal ID value as shown in Table 1, Table 2, and Table 3. However, in video coding, it is not required to assign pictures to Temporal ID values as shown in those tables. Instead, sublayers and Temporal ID values may not be used at all, or all pictures may be assigned to sublayer 0. Table 4 shows an example where all pictures belong to sublayer 0. The decoding orders in Table 2 and Table 4 are identical, so one can say that the virtual Temporal ID represent the Temporal ID value that would have been used for a picture if sublayers would have been used.

The idea of this embodiment 3 is to signal one delta QP value per virtual Temporal ID value rather than signal one delta QP value per picture position in a sub-GOP. For the example in Table 4 there would be 4 delta QP values signaled instead of 8. This saves bits, but limits the flexibility since every picture or slice that belongs to the same virtual Temporal ID has to have the same delta QP value. This is however commonly the case.

TABLE 4
Virtual temporal ID example (sub-GOP size = 8)

| | | | | | | | | |
|---|---|---|---|---|---|---|---|---|
| 0 | X | | X | | X | | X | |
| 0 | | X | | | | X | | |
| 0 | | | | X | | | | |
| 0 | | | | | | | | X |
| Output order | 0 | 1 | 2 | 3 | 4 | 5 | 6 | 7 |
| Decoding order | 3 | 2 | 4 | 1 | 6 | 5 | 7 | 0 |
| Temporal ID | 0 | 0 | 0 | 0 | 0 | 0 | 0 | 0 |
| Virtual Temporal | 3 | 2 | 3 | 1 | 3 | 2 | 3 | 0 |
| ID | | | | | | | | |

Now, in this embodiment it is assumed that a hierarchical structure of pictures of a sub-GOP size equal to N is used and that the LOL includes an entry for each of the N pictures in the structure, where the entries are ordered in decoding order. This means that for two consecutive pictures in decoding order, if an index value IV equal to K is decoded for the first picture, an index value equal to K+1 is decoded for the second picture.

Using Table 4 as an example, there may be 8 consecutive entries in the LOL for pictures corresponding to the pictures with decoding order 0, 1, 2, 3, 4, 5, 6, and 7.

For such an entry, this embodiment 3 works as follows: an index value IV is decoded from a header (e.g., a picture header or a slice header or a segment header) of the current coded picture where the index value is one of the N consecutive entries as just explained. From this index value, a virtual Temporal ID value T is derived. Then an index look-up operation on the list of delta QP values with the index being used in the look-up operation being equal to the value T to derive the delta QP value.

Example pseudo-code for implementing this embodiment is shown in the table below:

TABLE 5
int index_value = READ_SYNTAX_ELEMENT( );
List *selected_list_of_reference_picture_indicator_values =
LOL[index_value];
int virtual_temporal_id_value = convert(index_value);
int delta_qp_value = LIST_of_Delta_QP_values[virtual_temporal_id_value];
DecodeSegment(selected_list_of_reference_picture_indicator_values,
delta_qp_value);

Here, the function convert( ) derives a virtual Temporal ID value from the index value.

In one embodiment, the function convert( ) is implemented as shown by the following pseudo code:

TABLE 6

```
int convert(const int index_value)
{
  int virtual_tID;
  int temp = POC[index_value]+1;
  for (virtual_tID = N ; virtual_tID > 0
  && !(temp & 1) ; virtual_tID−−)
    temp >>= 1;
  return virtual_tID;
}
```

where POC is an array that, for an index i representing a decoding order value for a picture, contains the output order value for that picture given a particular sub-GOP size equal to 2\hat{ }N.

In one embodiment, the following pseudo-code may be used to create the array POC given a particular sub-GOP size equal to 2\hat{ }N.

TABLE 7

static const int POC_values_for_gop_64[64] = {
63, 31, 15, 7, 3, 1, 0, 2, 5, 4
6, 11, 9, 8, 10, 13, 12, 14, 23, 19
17, 16, 18, 21, 20, 22, 27, 25, 24, 26
29, 28, 30, 47, 39, 35, 33, 32, 34, 37
36, 38, 43, 41, 40, 42, 45, 44, 46, 55
51, 49, 48, 50, 53, 52, 54, 59, 57, 56
58, 61, 60, 62 };
int *POC = POC_values_for_gop_64 + 6 − N;

Using Table 4 as an example, the value N is equal to 3 since the sub-GOP size in Error! Reference source not found. is equal to 2\hat{ }3=8. This gives: int*POC=POC_values_for_gop_64+6−3.

This makes the first 8 values in the array POC equal to 7, 3, 1, 0, 2, 5, 4, 6. These are the POC values for the pictures with values 0-7 in decoding order in Error! Reference source not found. The “Output order” number in Table 4 for a picture is given by POC [decoding_order], where decoding_order is set equal to the value of “Decoding order” for the picture in Table 4.

A decoder may perform the following steps to decode a current picture according to this embodiment:
1) Deriving a list of delta QP values from the parameter set syntax elements, wherein each entry in the list of delta QP value comprises a delta QP value;
2) Deriving an LOL from the parameter set syntax elements, wherein each entry in the LOL comprises at least one list of reference picture indicator values;
3) Decoding an index value from the slice header or picture header or segment header of the current coded picture;
4) Deriving a virtual temporal ID value from the index value;
5) Deriving a delta QP value from the virtual temporal ID value and the list of delta QP values (this derivation may be done using an index look-up operation on the list of delta QP values with the index used in the look-up operation being equal to the virtual temporal ID value to derive the delta QP value);
6) Using the derived delta QP value to derive an initial QP value (QPi) for a current coded picture (e.g., calculating QPi=X+d_delta_QP_value, where d_delta_QP_value is the derived delta QP value and X is a predicted initial QP value);
7) Using an index look-up operation on the LOL with the index equal to the index value to select from the LOL at least one list of reference picture indicator values (RPIVs); and
8) Using the initial QP value and the selected list of RPIVs in a decoding process to decode the current coded picture.

### Embodiment 4—Deriving a Virtual Temporal ID Value

In this embodiment, a method for deriving the virtual temporal ID value for a coded picture is described. The virtual temporal ID value is derived from a first value and a second value, that in turn are derived from the bitstream, where the first value represents a decoding order value of the coded picture and the second value represents a sub-GOP size of a sub-GOP that the picture belongs to. The first and the second value may be derived by a decoder by decoding two syntax elements, one for each value. The second value may represent the log 2 value of a sub-GOP size.

When the first value is derived, a POC value is derived from the first value by an index look-up operation with the index in the look-up operation equal to the first value. Thereafter the virtual temporal ID value is derived from the POC value and the second value.

The virtual temporal ID value (virtual_tID) may be derived from the POC value (POC) and the second value (N) as shown by the following pseudo code:

TABLE 8
for (virtual_tID = N ; virtual_tID > 0 && !(POC & 1) ; virtual_tID−−)
POC >>= 1;

A decoder may perform the following steps for deriving a virtual temporal ID value a coded video bitstream according to this embodiment:
1) Decoding a first value representing a decoding order value from a first syntax element in the bitstream;
2) Decoding a second value from a second syntax element in the bitstream representing a sub-GOP size wherein the second value represents the log 2 of the sub-GOP size; (the sub-GOP size may be equal to 2\hat{ }V, where V is equal to the second value)
3) Deriving a POC value from the first value, wherein the POC value is derived from the first value by an index look-up operation with the index in the look-up operation equal to the first value; and
4) Deriving a virtual temporal ID value from the POC value and the second value. The virtual temporal ID (virtual_tID) value may be derived from the POC value (POC) and the second value (N) as shown in table 8.

In some embodiments, the index value is the “first value” described above. That is, in some embodiments, the index value represents a decoding order value of the coded picture.

### Embodiment 5—Syntax Table and Pseudocode

An embodiment was implemented on top of the ECM-6.0 experimental video codec. The ECM-6.0 codec is built on top of VVC and uses the VVC handling of reference picture lists (RPLs). The implementation added two syntax elements to the ECM-6.0 sequence parameter set as shown in Table 9 below where lines 4-6 are added. The syntax table format follows that of the VVC specification where syntax elements are shown in bold, and the Descriptor column shows the syntax element type. ue(v) is a UVLC codeword and se(v) is a signed UVLC codeword.

TABLE 9

| | | Descriptor |
|---|---|---|
| 1 | seq_parameter_set_rbsp( ) { | |
| 2 | ... | |
| 3 | sps_{—}num_{—}ref_{—}pic_{—}lists | ue(v) |
| 4 | nr_{—}vtls | ue(v) |
| 5 | for ( i = 0 ; i < (nr_vtls > 0 ? nr_vtls + 1 : sps_num_ref_pic_lists ) ; i ++ ) | |
| 6 | qp_{—}delta[ i ] | se(v) |

Line 3 is a syntax element specifying the number of reference picture lists there are in the SPS.

Line 4 is a syntax element specifying the number of virtual temporal layers. The value 0 means that there are no virtual temporal layers. When that is the case, the for loop on line 5 results in one qp_delta value to be decoded for each reference picture list there is in the SPS. This means that each decoded qp_delta value is associated with an entry in the LOL. This corresponds to embodiment 2 and was used to generate the low-delay configuration results shown below.

When the number of virtual temporal layers (nr_vtls) is greater than 0, the for loop on line 5 results in one qp_delta value to be decoded for each virtual temporal layer. As an example, when nr_vtls is greater than 0, for example equal to 3, a value equal to 3 indicates that there are 2\hat{ }3=8 pictures in the sub-GOP. There will then be 4 qp_delta values decoded, and they will be applied to pictures in a sub-GOP of 8 pictures as shown in Table 10 below.

TABLE 10

| | POC |
|---|---|
| qp_delta[0] | 0, 8, . . . |
| qp_delta[1] | 4, 12, . . . |
| qp_delta[2] | 2, 6, 10, . . . |
| qp_delta[3] | 1, 3, 5, 7, 9, . . . |

When a value greater than 0 is decoded for nr_vtls, the qp_delta[i] value will be stored with the RPL entry that corresponds to the POC value of the table above.

Table 11 below illustrates i) example pseudocode for decoding an SPS and ii) example pseudocode for decodig a slice header.

```
TABLE 11
//////////////////////////////////////////
// pseudo-code run when decoding an SPS //
//////////////////////////////////////////
static const int POC_values_for_gop_64[64] = {
63, 31, 15, 7, 3, 1, 0, 2, 5, 4
  6, 11, 9, 8, 10, 13, 12, 14, 23, 19
17, 16, 18, 21, 20, 22, 27, 25, 24, 26
29, 28, 30, 47, 39, 35, 33, 32, 34, 37
36, 38, 43, 41, 40, 42, 45, 44, 46, 55
51, 49, 48, 50, 53, 52, 54, 59, 57, 56
58, 61, 60, 62 };
const int *POC = NULL;
uint32_t code;
uint32_t hierarchicalLevels = 0;
std::vector<int> QP_OFFSET;
int numberOfRPL;
int TEMP[7] = { 0,0,0,0,0,0,0 };
READ_UVLC(numberOfRPL, “sps_num_ref_pic_lists”);
READ_UVLC(hierarchicalLevels, “nr_vtls”);
POC = POC_values_for_gop_64 + 6 − hierarchicalLevels;
for (int i = 0; i < (hierarchicalLevels > 0 ? hierarchicalLevels + 1 : numberOfRPL); i++)
{
  if (hierarchicalLevels > 0)
    READ_SVLC(TEMP[i], “qp_delta”);
  else
    READ_SVLC(QP_OFFSET[i], “qp_delta”);
}
for (int rplIdx = 0; rplIdx < numberOfRPL; rplIdx++)
{
  if (hierarchicalLevels > 0)
  {
    if(rplIdx < (1<< hierarchicalLevels))
    {
      int tID;
      int temp = POC[rplIdx]+1;
      for (tID = hierarchicalLevels; tID > 0 && !(temp & 1); tID−−)
        temp >>= 1;
      QP_OFFSET[rplIdx] = TEMP[tID];
    }
    else
    {
      QP_OFFSET[rplIdx] = 0;
    }
  }
}
//////////////////////////////////////////////////
// pseudo-code run when decoding a slice header //
//////////////////////////////////////////////////
// These two lines are original ECM-6.0 code
READ_SVLC(iCode, “slice_qp_delta”);
int qpDelta = iCode;
// These three lines are added for the method
int idx = pcSlice->getRPLidx( );
if (!pcSlice->isIntra( ) && idx >= 0)
  qpDelta = qpDelta + QP_OFFSET[idx];
```

### Embodiment 6—Delta Coding of qp Deltas

In some cases, it may be advantageous to encode the difference between a certain qp_delta[k] and a previous qp_delta[k−1] instead of encoding the qp_delta[k] value directly. Taking the GOP32 structure that is used in the current CTC for ECM, we have the following qp_offsets:

### Embodiment 6—Delta Coding of qp Deltas

TABLE 12

| POC | qp_offset |
|---|---|
| 0 | −1 |
| 32 | −1 |
| 16 | 0 |
| 8 | 0 |
| 4 | 3 |
| 2 | 5 |
| 1 | 6 |
| 3 | 6 |
| 6 | 5 |
| 5 | 6 |
| 7 | 6 |
| 12 | 3 |
| 10 | 5 |
| 9 | 6 |
| 11 | 6 |
| 14 | 5 |
| 13 | 6 |
| 15 | 6 |
| 24 | 0 |
| 20 | 3 |
| 18 | 5 |
| 17 | 6 |
| 19 | 6 |
| 22 | 5 |
| 21 | 6 |
| 23 | 6 |
| 28 | 3 |
| 26 | 5 |
| 25 | 6 |
| 27 | 6 |
| 30 | 5 |
| 29 | 6 |
| 31 | 6 |

This translates to the following qp_deltas:

TABLE 13

qp_delta[0] = −1
qp_delta[1] = 0
qp_delta[2] = 0
qp_delta[3] = 3
qp_delta[4] = 5
qp_delta[5] = 6

Here
qp_delta[0]=−1 should be used for POC 0 and 32,
qp_delta[1]=0 should be used for POC 16,
qp_delta[2]=0 should be used for POC 8 and 24,
qp_delta[3]=3 should be used for POC 4, 12, 20 and 28,
qp_delta[4]=5 should be used for POC 2, 6, 10, 14, 18, 22, 26 and 30,
qp_delta[5]=6 should be used for all odd-numbered POCs.

We thus need to signal this list:

$$qp\_delta [ 0 ] = - 1$$

$$qp\_delta [ 1 ] = 0$$

$$qp\_delta [ 2 ] = 0$$

$$qp\_delta [ 3 ] = 3$$

$$qp\_delta [ 4 ] = 5$$

$$qp\_delta [ 5 ] = 6$$

In a previous embodiment, we simply send the numbers −1, 0, 0, 3, 5 and 6 using se (v). However, this embodiment, we send the delta compared to the previous value, d_qp_delta[k]:

$$d\_qp \_delta [ 0 ] = - 1$$

$$d\_qp \_delta [ 1 ] = + 1$$

$$d\_qp \_delta [ 2 ] = 0$$

$$d\_qp \_delta [ 3 ] = 3$$

$$d\_qp \_delta [ 4 ] = 2$$

$$d\_qp \_delta [ 5 ] = 1$$

That is, we send the numbers −1, +1, 0, +3, +2, +1 using se (v). Since this typically results in smaller magnitudes, this will result in fewer bits in the bitstream. We can then reconstruct the qp_delta[k] as shown below:

TABLE 14

qp_delta[0] = d_qp_delta[0]
for k = 1 to 5
qp_delta[k] = qp_delta[k−1] + d_qp_delta[k]

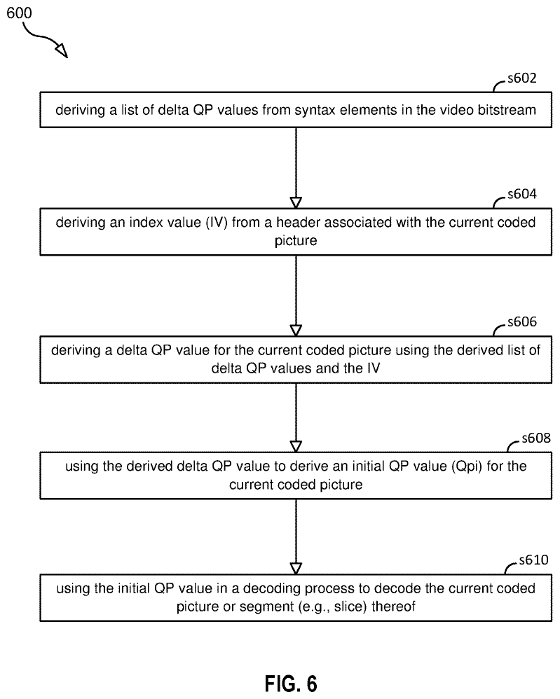

FIG. 6 is a flowchart illustrating a process 600 for decoding a current coded picture from a video bitstream. Process 600 may begin in step s602. Step s602 comprises deriving a list of delta quantization parameter, QP, values from parameter set syntax elements in the video bitstream (e.g., deriving a list of entries, wherein each entry in the list comprises a delta QP value) (in some embodiments, each delta QP value in the list is derived from a syntax element, and in some embodiments deriving a value from a syntax element comprises decoding the value from the syntax element). Step s604 comprises deriving an index value, IV, from one or more syntax elements in a slice header, a segment header or a picture header, associated with the current coded picture. Step s606 comprises deriving a delta QP value for the current coded picture using the derived list of delta QP values and the IV (e.g., using the IV value to select a delta QP value from the list of delta QP values). Step s608 comprises using the derived delta QP value to derive an initial QP value, QPi, for the current coded picture (e.g., calculating QPi=X+d_delta_QP_value, where d_delta_QP_value is the derived delta QP value and X is a predicted initial QP value). Step s610 comprises using the initial QP value in a decoding process to decode the current coded picture or segment (e.g., slice) thereof.

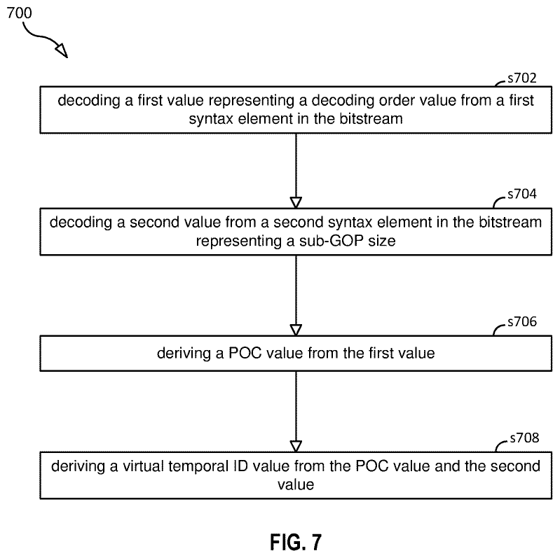

FIG. 7 is a flowchart illustrating a process 700 for deriving a virtual temporal ID value from a coded video bitstream. Process 700 may begin in step s702. Step s702 comprises decoding a first value representing a decoding order value from a first syntax element in the bitstream. Step s704 comprises decoding a second value from a second syntax element in the bitstream representing a sub-GOP size wherein the second value represents the log 2 of the sub-GOP size (e.g., second value=log 2 (sub-GOP size) or log (sub-GOP size −1) or, more generally, log 2 (f (sub-GOP size))). Step s706 comprises deriving a POC value from the first value, wherein the POC value is derived from the first value by an index look-up operation with the index in the look-up operation equal to the first value. Step s708 comprises deriving a virtual temporal ID value from the POC value and the second value.

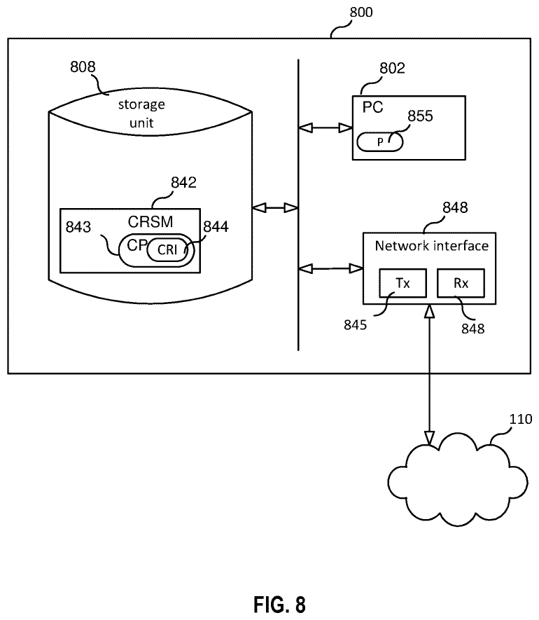

FIG. 8 is a block diagram of an apparatus 800 for implementing encoder 102 and/or decoder 104, according to some embodiments. When apparatus 800 implements encoder 102, apparatus 800 may be referred to as an encoder apparatus, and when apparatus 800 implements decoder 104, apparatus 800 may be referred to as a decoder apparatus. As shown in FIG. 8, apparatus 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 800 may be a distributed computing apparatus); at least one network interface 848 (e.g., a physical interface or air interface) comprising a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling encoder apparatus 800 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes encoder apparatus 800 to perform steps described herein (e.g., steps described herein with reference to the flow charts). In other embodiments, encoder apparatus 800 may be configured to perform steps described herein without the need for code. That is, for example, PC 802 may consist merely of one or more ASICs. Hence, the features of the embodiments described herein may be implemented in hardware and/or software.

### Summary of Various Embodiments

A1. A method (600) for decoding a current coded picture from a video bitstream, the method comprising:
deriving a list of delta quantization parameter, QP, values from syntax elements (e.g., parameter set syntax elements) in the video bitstream (e.g., deriving a list of entries, wherein each entry in the list comprises a delta QP value) (in some embodiments, each delta QP value in the list is derived from a syntax element, and in some embodiments deriving a value from a syntax element comprises decoding the value from the syntax element);
deriving an index value, IV, from a header (e.g., deriving the IV from one or more syntax elements in a slice header or a segment header or a picture header) associated with the current coded picture;
deriving a delta QP value for the current coded picture using the derived list of delta QP values and the IV (e.g., using the IV value to select a delta QP value from the list of delta QP values);
using the derived delta QP value to derive an initial QP value, QPi, for the current coded picture (e.g., calculating QPi=X+d_delta_QP_value, where d_delta_QP_value is the derived delta QP value and X is a predicted initial QP value); and
using the initial QP value in a decoding process to decode the current coded picture or segment (e.g., slice) thereof.
A2. The method of embodiment A1, wherein the parameter set syntax elements are present in at least one of a DPS (a.k.a. DCI), VPS, SPS, PPS, or APS.
A3. The method of embodiment A1 or A2, further comprising:
deriving a list of lists (LOL) from the syntax elements, wherein each entry in the LOL comprises a first list of reference picture indicator values;
using the IV and the LOL to select from the LOL at least one list of reference picture indicator values (RPIVs); and
using the initial QP value and the selected at least one list of RPIVs in the decoding process.
A3.1 The method of embodiment A3, further comprising using an index look-up operation with the index equal to the IV to select from the LOL at least one list of RPIVs.
A4. The method of any one of the above embodiments, wherein deriving the delta QP value comprises using the index value to select a delta QP value from the list of delta QP values.
A5. The method of embodiment A4, wherein
deriving the list of delta QP values comprises deriving a list (e.g., an array) of entries, wherein each entry in the list comprises a delta QP value; and
deriving the delta QP value comprises performing an index look-up operation on the list using an index equal to the index value.
A6. The method of any one of embodiments A1-A3, wherein deriving the delta QP value comprises:
derive a virtual temporal ID value associated with the current coded picture; and
using the virtual temporal ID value to select a delta QP value from the list of delta QP values.
A6.1. The method of A6, wherein the virtual temporal ID is derived using the IV.
A6.2. The method of any of the above embodiments, wherein the IV represents a decoding order value of the coded picture.
A7. The method of embodiment A6, A6.1, or A6.2, wherein deriving the list of delta QP values comprises deriving a list (e.g., an array) of entries, wherein each entry in the list comprises a delta QP value; and deriving the delta QP value comprises performing an index look-up operation on the list using an index equal to the virtual temporal ID value.
A8. The method of embodiment A6.1, A6.2, or A7, wherein using the IV to derive the virtual temporal ID value comprises:
using the IV to derive a picture order count, POC, value; and
using the POC value to derive the virtual temporal ID value.
A9. The method of embodiment A6.1, A6.2, A7, or A8, wherein using the index value, IV, to derive the virtual temporal ID value comprises:
decoding a value representing a sub-GOP size from a syntax element in the bitstream wherein the value representing a sub-GOP size represents the log 2 of the sub-GOP size;
deriving a POC value from the index value, wherein the POC value is derived from the index value by an index look-up operation with the index in the look-up operation equal to the index value; and
deriving a virtual temporal ID value from the POC value and the value representing the sub-GOP size.
A10. A method for deriving a virtual temporal ID value from a coded video bitstream, the method comprising:
decoding a first value representing a decoding order value from a first syntax element in the bitstream;
decoding a second value from a second syntax element in the bitstream representing a sub-GOP size wherein the second value represents the log 2 of the sub-GOP size;
deriving a POC value from the first value, wherein the POC value is derived from the first value by an index look-up operation with the index in the look-up operation equal to the first value; and
deriving the virtual temporal ID value from the POC value and the second value.
A11. The method of any one of embodiments A8-A10, wherein the virtual temporal ID (virtual_tID) value is derived from the POC value (POC) and the second value (N) as follows:
for (virtual_tID=N; virtual_tID>0 && !(POC & 1); virtual_tID--) {POC>>=1;}.
A12. The method of embodiment A10 or A11, wherein
the first syntax element is in a header, and
the second syntax element is in a parameter set.
B1. A computer program (843) comprising instructions (844) which when executed by processing circuitry (802) of an apparatus (800) causes the apparatus to perform the method of any one of the above embodiments.
B2. A carrier containing the computer program of embodiment B1, wherein the carrier is one of an electronic signal, an optical signal, a radio signal, and a computer readable storage medium (842).
C1. A decoder apparatus (800) configured to perform the method of any one of embodiments A1-A12.

### RESULTS AND CONCLUSION

The embodiments are advantageous in that they provide video compression bit-rate savings. A method according to this disclosure was implemented on top of the ECM-6.0 experimental video codec and tested according to the testing procedures specified by MPEG and ITU-T in document JVET-Y2017, jvet-experts (dot) org/doc_end_user/current_document.php?id=11473. On the so-called Class D test set, the method provides bit-rate savings up to 0.37% compared to ECM-6.0 as-is for the random-access configuration and up to 0.38% for the low-delay configuration, as shown in the Table 15 and Table 16.

TABLE 15
Result for random-access Class D

| | | | BD-rate (cubic) | |
|---|---|---|---|---|
| | | QPISlice | Y | |
| Class D | BasketballPass | 22 | −0.09% | −0.02% |
| WQVGA | | 27 | | −0.05% |
| | | 32 | | −0.12% |
| | | 37 | | −0.23% |
| | BQSquare | 22 | −0.15% | −0.03% |
| | | 27 | | −0.09% |
| | | 32 | | −0.20% |
| | | 37 | | −0.37% |
| | BlowingBubbles | 22 | −0.10% | −0.02% |
| | | 27 | | −0.05% |
| | | 32 | | −0.12% |
| | | 37 | | −0.26% |
| | RaceHorses | 22 | −0.06% | −0.01% |
| | | 27 | | −0.03% |
| | | 32 | | −0.07% |
| | | 37 | | −0.14% |

| | |
|---|---|
| Class D average | −0.10% |

TABLE 16
Result for low-delay Class D

| | | | BD-rate (cubic) | |
|---|---|---|---|---|
| | | QPISlice | Y | |
| Class D | BasketballPass | 22 | −0.09% | −0.02% |
| WQVGA | | 27 | | −0.06% |
| | | 32 | | −0.11% |
| | | 37 | | −0.23% |
| | BQSquare | 22 | −0.14% | −0.02% |
| | | 27 | | −0.08% |
| | | 32 | | −0.18% |
| | | 37 | | −0.38% |
| | BlowingBubbles | 22 | −0.09% | −0.02% |
| | | 27 | | −0.06% |
| | | 32 | | −0.12% |
| | | 37 | | −0.22% |
| | RaceHorses | 22 | −0.05% | −0.01% |
| | | 27 | | −0.04% |
| | | 32 | | −0.07% |
| | | 37 | | −0.15% |

| | |
|---|---|
| Class D average | −0.09% |

The method was implemented on the sequence-level and the computational complexity that the method adds is negligible.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding a current coded picture from a video bitstream, the method comprising:
deriving a list of delta quantization parameter, (OP) values from parameter set syntax elements in the video bitstream;
deriving an index value, (IV) from one or more syntax elements in a slice header, a segment header or a picture header, associated with the current coded picture;
deriving a delta QP value for the current coded picture using the derived list of delta QP values and the IV;
using the derived delta QP value to derive an initial QP value (QPi) for the current coded picture; and
using the initial QP value in a decoding process to decode the current coded picture or segment thereof.

2. The method of claim 1, wherein the parameter set syntax elements are present in a decoding parameter set, a video parameter set, a sequence parameter set, a picture parameter set, and/or an adaptation parameter set.

3. The method of claim 1, further comprising:
deriving a list of lists, LOL, from the parameter set syntax elements, wherein each entry in the LOL comprises a first list of reference picture indicator values;
using the IV and the LOL to select from the LOL at least one list of reference picture indicator values, RPIVs; and
using the initial QP value and the selected at least one list of RPIVs in the decoding process.

4. The method of claim 3, wherein the method further comprises using an index look-up operation with the index equal to the IV to select from the LOL at least one list of RPIVs.

5. The method of claim 1, wherein deriving the delta QP value comprises using the index value to select a delta QP value from the list of delta QP values.

6. The method of claim 5, wherein
deriving the list of delta QP values comprises deriving a list of entries, wherein each entry in the list comprises a delta QP value; and
deriving the delta QP value comprises performing an index look-up operation on the list using an index equal to the index value.

7. The method of claim 1, wherein deriving the delta QP value comprises:
deriving a virtual temporal ID value associated with the current coded picture; and
using the virtual temporal ID value to select a delta QP value from the list of delta QP values.

8. The method of claim 7, wherein the virtual temporal ID is derived using the IV.

9. The method of claim 1, wherein the IV represents a decoding order value of the coded picture.

10. The method of claim 7, wherein
deriving the list of delta QP values comprises deriving a list of entries, wherein each entry in the list comprises a delta QP value; and
deriving the delta QP value comprises performing an index look-up operation on the list using an index equal to the virtual temporal ID value.

11. The method of claim 8, wherein using the IV to derive the virtual temporal ID value comprises:
using the IV to derive a picture order count, POC, value; and
using the POC value to derive the virtual temporal ID value.

12. The method of claim 8, wherein using the index value, IV, to derive the virtual temporal ID value comprises:
decoding a value representing a sub-GOP size from a syntax element in the bitstream wherein the value representing a sub-GOP size represents the log 2 of the sub-GOP size;
deriving a POC value from the index value, wherein the POC value is derived from the index value by an index look-up operation with the index in the look-up operation equal to the index value; and
deriving a virtual temporal ID value from the POC value and the value representing the sub-GOP size.

13. A method for deriving a virtual temporal identifier (ID) value from a coded video bitstream, the method comprising:
decoding a first value representing a decoding order value from a first syntax element in the bitstream;
decoding a second value from a second syntax element in the bitstream representing a sub-GOP size wherein the second value represents the log 2 of the sub-GOP size;
deriving a picture order count (POC) value from the first value, wherein the POC value is derived from the first value by an index look-up operation with the index in the look-up operation equal to the first value; and
deriving the virtual temporal ID value from the POC value and the second value.

14. The method of of claim 11, wherein the virtual temporal ID, virtual_tID, value is derived from the POC value, POC, and the second value, N, as follows:
$$for ( virtual\_tID = N ; virtual\_tID > 0 \&\& ! ( POC \& 1 ) ; virtual\_tID -- ) \{ POC \text{>>=} 1 ; \} .$$

15. The method of claim 13, wherein
the first syntax element is in a header, and
the second syntax element is in a parameter set.

16. A non-transitory computer readable storage medium storing a computer program comprising instructions which when executed by processing circuitry of an apparatus causes the apparatus to perform the method of claim 1.

17. A non-transitory computer readable storage medium storing a computer program comprising instructions which when executed by processing circuitry of an apparatus causes the apparatus to perform the method of claim 13.

18. A decoder apparatus, the decoder apparatus comprising:
memory; and
processing circuitry, wherein the decoder apparatus is configured to perform a method for decoding a current coded picture from a video bitstream, the method comprising:
deriving a list of delta quantization parameter (QP) values from parameter set syntax elements in the video bitstream;
deriving an index value (IV) from one or more syntax elements in a slice header, a segment header or a picture header, associated with the current coded picture;
deriving a delta QP value for the current coded picture using the derived list of delta QP values and the IV;
using the derived delta QP value to derive an initial QP value (QPi) for the current coded picture; and
using the initial QP value in a decoding process to decode the current coded picture or segment thereof.

19. An apparatus, the apparatus comprising:
memory; and
processing circuitry, wherein the apparatus is configured to perform a method for deriving a virtual temporal identifier (ID) value from a coded video bitstream, the method comprising:
decoding a first value representing a decoding order value from a first syntax element in the bitstream;
decoding a second value from a second syntax element in the bitstream representing a sub-GOP size wherein the second value represents the log 2 of the sub-GOP size;
deriving a picture order count (POC) value from the first value, wherein the POC value is derived from the first value by an index look-up operation with the index in the look-up operation equal to the first value; and
deriving the virtual temporal ID value from the POC value and the second value.
